(19) United States
(12) Patent Application Publication
(10) Pub. No.: US 2025/0384109 A1
(43) Pub. Date: Dec. 18, 2025

(54) INFORMATION PROCESSING APPARATUS, INFORMATION PROCESSING METHOD, AND COMPUTER PROGRAM

(71) Applicant: SONY GROUP CORPORATION, TOKYO (JP)

(72) Inventors: YASUHIRO HORI, TOKYO (JP); KO KOBAYASHI, TOKYO (JP); TAKASHI ISOZAKI, TOKYO (JP)

(21) Appl. No.: 18/877,175

(22) PCT Filed: May 9, 2023
(86) PCT No.: PCT/JP2023/017448

§ 371 Date: Dec. 19, 2024

(30) Foreign Application Priority Data
Jun. 27, 2022 (JP) 2022-103062

(51) Int. Cl. G06F 17/18

(52) U.S. Cl. CPC G06F 17/18

(57) ABSTRACT

Provided is an information processing apparatus that performs processing for presenting a relationship between variables in multivariate analysis. The information processing apparatus includes a detection unit that detects a combination of two variables having a characteristic relationship in multivariate analysis, and a presentation unit that presents information regarding the characteristic relationship between the two variables. The detection unit detects whether or not there is a characteristic relationship including at least one of a positive correlation, a negative correlation, or a non-linear relationship as the entire variables on the basis of the relationship between the explanatory variable and the explained variable for each of the two consecutive categories of the explanatory variable, and further quantifies the relationship between the explanatory variable and the explained variable as the entire variables.

### TECHNICAL FIELD

The technology disclosed in the present specification (hereinafter, referred to as “present disclosure”) relates to an information processing apparatus, an information processing method, and a computer program that perform a process related to multivariate analysis.

### BACKGROUND ART

Multivariate analysis is a general term for statistical techniques for analyzing interrelationships between a plurality of variables, and an analysis result thereof is used for understanding a phenomenon that has already occurred, predicting the future, controlling, intervening, and the like. In multivariate analysis, one of basic matters is to estimate a relationship such as a correlation between two variables. In addition, it is often performed to express the estimated relationship between two variables or between multivariable as a graphical model such as a causal model because of the excellent readability of the analysis result of the multivariable data.

For example, there has been proposed an information processing apparatus including: a causal model estimation unit that inputs measurement data including an explanatory variable and an explained variable obtained from a discrimination target and estimates one or a plurality of causal models indicating a relationship between the explanatory variable and the explained variable; an evaluation unit that evaluates the one or the plurality of causal models using an index indicating prediction or discrimination performance for the explained variable and outputs a causal model in which a result of the evaluation satisfies a predetermined condition; and an editing unit that outputs the causal model output by the evaluation unit and a result of the evaluation to a display unit (see Patent Document 1).

In addition, there has been proposed a correlation extraction program that causes a computer to execute: a step of receiving designation of two variables among a plurality of variables constituting analysis data; a step of calculating each straight line passing through a centroid of the analysis data in a scatter diagram of the two variables; a step of extracting each data in which a deviation from each straight line does not exceed a threshold; a step of calculating each correlation coefficient from each data; a step of calculating each conditional probability of a single variable or/and a combination of variables; and a step of displaying the single variable or/and the combination of variables on a display unit on the basis of each correlation coefficient and each conditional probability (see Patent Document 2).

### CITATION LIST

### Patent Document

PATENT DOCUMENT 1 Japanese Patent Application Laid-Open No. 2020-194320
PATENT DOCUMENT 2 Japanese Patent Application Laid-Open No. 2020-154890

### SUMMARY OF THE INVENTION

### Problems to be Solved by the Invention

An object of the present disclosure is to provide an information processing apparatus, an information processing method, and a computer program that perform processing for presenting a relationship between variables in multivariate analysis.

### Solutions to Problems

The present disclosure has been made in view of the above problems, and a first aspect thereof is
an information processing apparatus including:
a detection unit that detects a combination of two variables having a characteristic relationship in multivariate analysis; and
a presentation unit that presents information regarding the characteristic relationship between the two variables.

The detection unit detects the characteristic relationship by quantifying a relationship between the two variables that are qualitative variables and are ordinal scales by a mathematical formula. Specifically, the detection unit derives a relationship between an explanatory variable and an explained variable for each of two consecutive categories of the explanatory variable, on the basis of a change in distribution of each category of the explained variable in the two consecutive categories of the explanatory variable, in a relationship between the explanatory variable and the explained variable that are qualitative variables and are ordinal scales, and detects whether or not there is a characteristic relationship including at least one of a positive correlation, a negative correlation, or a non-linear relationship as entire variables on the basis of the relationship between the explanatory variable and the explained variable for each of the two consecutive categories of the explanatory variable.

In addition, the detection unit further quantifies the relationship between the explanatory variable and the explained variable as entire variables. Specifically, the detection unit calculates a correlation index indicating the relationship between the variables as the entire variables by summing, over all categories of the explanatory variable, sub-correlation indexes based on a change in an occupancy probability of an upper category of the explained variable and a change in an occupancy probability of a lower category of the explained variable between the two consecutive categories of the explanatory variable.

The presentation unit presents information regarding a relationship between variables, the information including at least one of a mutual information amount between the variables that are qualitative variables and are ordinal scales, or a correlation index obtained by quantifying a strength of correlation as entire variables. Furthermore, the presentation unit presents information regarding a relationship between two variables, including whether the entire variables have a positive correlation, a negative correlation, or a non-linear relationship.

Further, a second aspect of the present disclosure is
an information processing method including:
a detection step of detecting a combination of two variables having a characteristic relationship in multivariate analysis; and
a presentation step of presenting information regarding the characteristic relationship between the two variables.

Further, a third aspect of the present disclosure is
a computer program written in a computer-readable format for causing a computer to function as:
a detection unit that detects a combination of two variables having a characteristic relationship in multivariate analysis; and
a presentation unit that presents information regarding the characteristic relationship between the two variables.

The computer program according to the third aspect of the present disclosure defines a computer program written in a computer-readable format in such a way as to achieve predetermined processing in the computer. In other words, by installing the computer program according to the third aspect of the present disclosure in the computer, the computer can perform a cooperative operation and produce functions and effects similar to those produced by the information processing apparatus according to the first aspect of the present disclosure.

### Effects of the Invention

According to the present disclosure, it is possible to provide an information processing apparatus, an information processing method, and a computer program that search for and further visualize a characteristic relationship between variables in multivariate analysis.

Note that the effects described herein are merely examples, and the effects produced by the present disclosure are not limited to these. Furthermore, the present disclosure may also produce additional effects in addition to the effects described above.

Other objects, features, and advantages of the present disclosure will become apparent from more detailed description based on embodiments that will be described later and the accompanying drawings.

### BRIEF DESCRIPTION OF DRAWINGS

FIG. 1 is a diagram illustrating an example of a conditional probability chart between an explanatory variable and an explained variable.

FIG. 2 is a diagram illustrating a state of deriving a relationship between variables for each pair of two consecutive categories of the explanatory variable.

FIG. 3 is a diagram illustrating a relationship between an explanatory variable and an explained variable between categories over the entire explanatory variable.

FIG. 4 is a diagram illustrating a method of calculating a sub-correlation index Z_{sub} for each pair of two consecutive categories of the explanatory variable to derive a relationship between variables.

FIG. 5 is a flowchart illustrating a processing procedure for calculating a correlation index Z between an explanatory variable and an explained variable.

FIG. 6 is a diagram illustrating processes e01, e02, and e03 included in the calculation formula of the correlation index Z (in a case where the total number of categories M of the explained variable is an even number).

FIG. 7 is a diagram illustrating processes o01, o02, and o03 included in the calculation formula of the correlation index Z (in a case where the total number of categories M of the explained variable is an odd number).

FIG. 8 is a diagram illustrating a functional configuration example of an information processing system 800.

FIG. 9 is a diagram illustrating a display example of visualizing information regarding a characteristic relationship between two variables using a causal graph.

FIG. 10 is a diagram illustrating a display example of visualizing information regarding a characteristic relationship between two variables using a causal graph.

FIG. 11 is a diagram illustrating another display example of visualizing information regarding a characteristic relationship between two variables using a causal graph.

FIG. 12 is a diagram illustrating still another display example of visualizing information regarding a characteristic relationship between two variables using a causal graph.

FIG. 13 is a view illustrating a modification of FIG. 12.

FIG. 14 is a diagram illustrating a display example of visualizing information regarding a relationship between two variables on a graph including nodes corresponding to the two variables and the edge.

FIG. 15 is a diagram illustrating an example of a graph visualizing a result of data analysis (Example (1)).

FIG. 16 is a diagram illustrating a conditional probability chart between two variables (Example (1)).

FIG. 17 is a diagram illustrating an example of a graph visualizing a result of data analysis (Example (2)).

FIG. 18 is a diagram illustrating a conditional probability table between two variables (Example (2)).

FIG. 19 is a diagram illustrating a configuration example of an information processing apparatus 2000.

FIG. 20 is a diagram illustrating an example of a scatter diagram of two variables having a positive correlation.

FIG. 21 is a diagram illustrating an example of a scatter diagram of two variables having a negative correlation.

FIG. 22 is a diagram illustrating an example of a scatter diagram of two variables having a non-linear relationship.

FIG. 23 is a diagram illustrating an example of a table illustrating a relationship between two variables for each combination of variables in the format of a list.

FIG. 24 is a diagram illustrating an example of a table illustrating a relationship between two variables for each combination of variables in the format of a matrix.

### MODE FOR CARRYING OUT THE INVENTION

The present disclosure will be described hereinafter in the following order with reference to the drawings.
A. Outline
B. Introduction of Correlation Index
B-1. Partial Correlation of Variables
B-2. Quantification of Correlation Tendency by Mathematical Formula
C. System Configuration Example
D. Example (1)
E. Example (2)
F. Apparatus Configuration
G. Summary

### A. Outline

In multivariate analysis, estimating a relationship between two variables is one of basic matters. In general, the relationship between two variables is visualized and confirmed by, for example, numerical data such as a correlation coefficient and a mutual information amount, a scatter diagram, a conditional probability chart, or the like.

However, in numerical data such as a correlation coefficient and a mutual information amount, a positive and negative correlation tendency and strength of the relationship as the entire variables can be grasped, but a relationship of nonlinearity such as a tendency different from others in some conditions (for example, the distribution of the explained variable is different only in some states of the explanatory variable) cannot be found. There is a such problem.

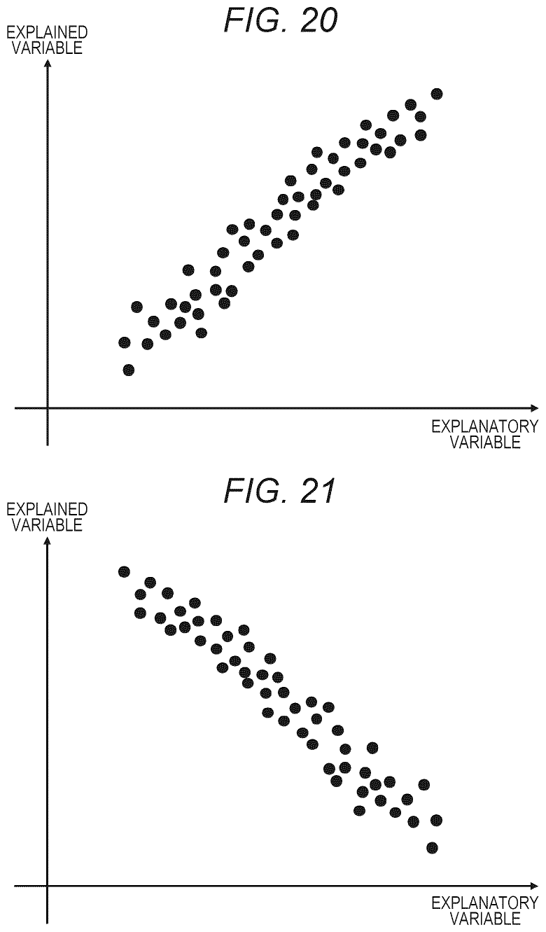

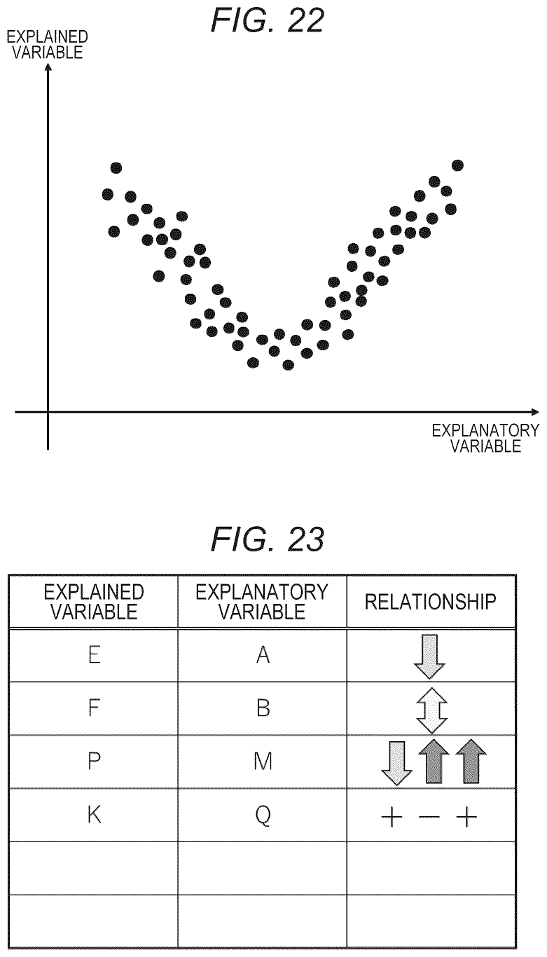

For example, in a case where the relationship between two variables is expressed on a scatter diagram, there may be a characteristic relationship such as nonlinearity between variables such that the relationship with the explained variable is switched by the state transition of the explanatory variable as illustrated in FIG. 22 (in the example illustrated in FIG. 22, the relationship between variables is switched from negative correlation to positive correlation) in addition to a case where there is a linear relationship across the entire variables such as a case where there is a positive correlation across the entire variables as illustrated in FIG. 20 and a case where there is a negative correlation across the entire variables as illustrated in FIG. 21. The correlation coefficient is a value obtained by dividing the covariance of the variable by the product of the standard deviation for each variable, and as illustrated in FIGS. 20 and 21, a positive/negative correlation tendency can be expressed as the entire variables. On the other hand, as illustrated in FIG. 22, in a case where the relationship between variables is non-linear, the positive correlation portion and the negative correlation portion cancel each other, and a small correlation coefficient is obtained. Therefore, it is difficult to express the non-linear relationship between variables. Similarly, it is difficult to express a non-linear relationship between variables in the mutual information amount.

In addition, when a visualization method such as a scatter diagram or a conditional probability chart is used, a non-linear relationship between variables can be expressed, but there is a problem that the number of operation steps by an analyst for confirmation increases, and there is a problem that nonlinearity may not be objectively found due to experience, bias, or the like of the analyst since it depends on visual judgment by a person.

Therefore, the present disclosure proposes a technique for efficiently searching for a characteristic or unexpected relationship between variables from among relationships of many variables in multivariate analysis. Furthermore, the present disclosure proposes a technology for visualizing and expressing a characteristic or unexpected relationship among relationships of many variables in multivariate analysis.

### B. Introduction of Correlation Index

### B-1. Partial Correlation of Variables

In the present disclosure, a relationship between two variables that are qualitative variables and are ordinal scales is quantified by a mathematical formula, and a combination of two variables having a characteristic relationship is efficiently searched from among relationships of many variables.

As is well known in the art, a quantitative variable is a variable that can be expressed numerically, whereas a qualitative variable is a variable that cannot be expressed numerically (alternatively, variables having different quality between data). In addition, the ordinal scale is a scale in which the order or the magnitude of the numerical value used for the qualitative variable has meaning. That is, the qualitative variable is a variable (category variable) including a plurality of categories that cannot be quantitatively expressed, and the order of each category and the magnitude of the numerical value of each category have meaning in the ordinal scale.

First, in the present disclosure, in a relationship between an explanatory variable and an explained variable that are qualitative variables and are ordinal scales, a change in distribution (occupancy probability) of each category of the explained variable in two consecutive categories of the explanatory variable is quantified by a mathematical formula to derive a correlation (that is, is positive correlation or negative correlation) between the explanatory variable and the explained variable in the two consecutive categories of the explanatory variable. Furthermore, in the present disclosure, whether or not a positive correlation, a negative correlation, or a non-linear relationship is included between the explanatory variable and the explained variable is detected in all transitions of the categories of the explanatory variable on the basis of the numerical value related to the relationship with the explained variable quantified for every two consecutive categories of the explanatory variable.

Then, in the present disclosure, two variables found to have a characteristic relationship such as a positive correlation, a negative correlation, or a non-linear relationship are visualized and presented on the basis of the detection result. For example, on the causal model, an edge connecting two variables having a characteristic relationship is displayed in a highlighted manner, or information regarding a relationship between two variables is displayed on the edge. Furthermore, in the present disclosure, an oriented graph in which nodes of variables having a characteristic relationship among many variables to be processed for multivariable analysis are connected by an edge may be displayed, and information regarding a relationship between two variables may be displayed together on the edge. The information regarding the relationship between the two variables mentioned here includes, for example, information regarding a mutual information amount and a non-linear correlation between the two variables, information regarding a change in the relationship between the variables accompanying the transition of the category of one variable (explanatory variable), and the like.

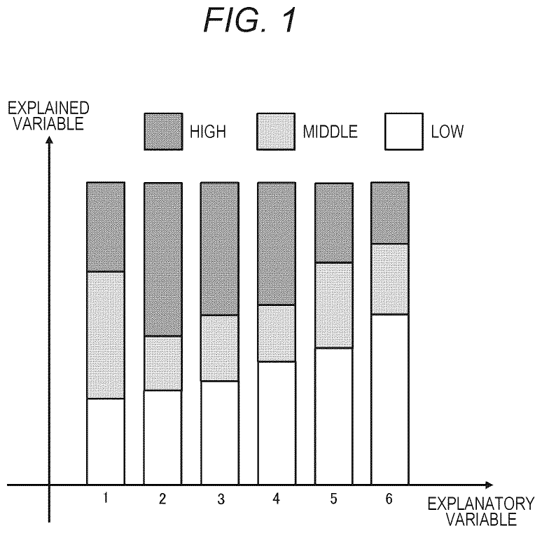

Here, a method of quantifying the relationship between the explanatory variable and the explained variable on the basis of the present disclosure will be described with an example in a case where there is the relationship as illustrated in FIG. 1 between the explanatory variable and the explained variable. As described above, both the explanatory variable and the explained variable are qualitative variables and are ordinal scales, and the explanatory variable is categorized into six stages of categories 1 to 6, while the explained variable is categorized into three stages of “high”, “medium”, and “low”. FIG. 1 illustrates a distribution of each category of the explained variable for each category of the explanatory variable. The “distribution” mentioned here is a ratio of the number of samples of each category of the explained variable, in other words, an occupancy probability. In short, FIG. 1 is a chart of the conditional probability illustrating the transition of the conditional probability that each category of the explained variable occurs for each category of the explanatory variable.

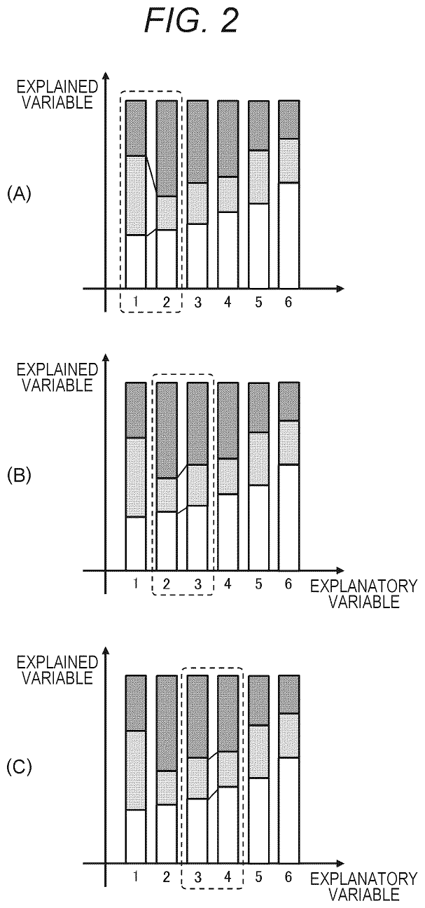

FIG. 2 illustrates a state of deriving a relationship with the explained variable for each pair of two consecutive categories of the explanatory variable in the conditional probability chart illustrated in FIG. 1. As illustrated in FIG. 2(A), when the explanatory variable transitions from category 1 to category 2, the occupancy probability of the upper category “high” of the explained variable increases. Therefore, in the transition of the explanatory variable from category 1 to category 2, since the transition of the category is also in the upper direction between the explanatory variable and the explained variable, it can be said that there is a positive correlation. Subsequently, as illustrated in FIG. 2(B), when the explanatory variable transitions from category 2 to category 3, the occupancy probability of the upper category “high” of the explained variable decreases, while the lower category “low” increases. Therefore, in the transition of the explanatory variable from category 2 to category 3, since the transition of the category is in the opposite direction between the explanatory variable and the explained variable, it can be said that there is a negative correlation. Subsequently, as illustrated in FIG. 2(C), also when the explanatory variable transitions from category 3 to category 4, the occupancy probability of the upper category “high” of the explained variable decreases, and the lower category “low” increases. Therefore, even in the transition of the explanatory variable from category 3 to category 4, the transition of the category is in the opposite direction between the explanatory variable and the explained variable, and it can be said that the explanatory variable and the explained variable continue to have a negative correlation.

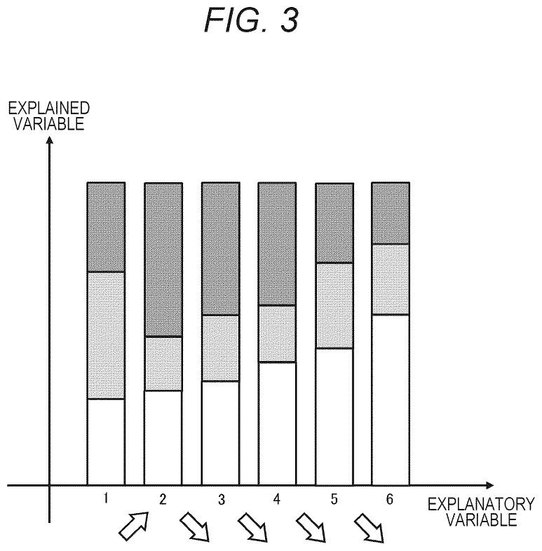

In FIG. 3, the relationship between the explanatory variable and the explained variable between the categories of the explanatory variable is expressed by an upper right arrow for the positive correlation and a lower right arrow for the negative correlation. In the conditional probability chart illustrated in FIG. 1, the positive and negative correlation tendency as the entire variables is not constant, and the correlation tendency with the explained variable changes in the transition of the category of the explanatory variable. Therefore, it can be concluded that there is a non-linear relationship between the explanatory variable and the explained variable.

As described above, according to the present disclosure, the relationship between a part of the explanatory variable and the explained variable can be derived by focusing on the change in the occupancy probability of each category of the explained variable for each pair of two consecutive categories of the explanatory variable.

### B-2. Quantification of Correlation Tendency by Mathematical Formula

In the above section B-1, the method of deriving the relationship with the objective function in some categories of the explanatory variable on the basis of the partial correlation of the variables, that is, the change in the occupancy probability of each category of the explained variable for each category transition has been described. Furthermore, according to the present disclosure, a characteristic relationship (there is a certain correlation tendency as the entire variables, there is a non-linear relationship, or the like) between an explanatory variable and an explained variable as the entire variables can be detected on the basis of a relationship between the explanatory variable and the explained variable derived for each category transition of the explanatory variable.

Therefore, in the present disclosure, in order to quantify the tendency of the correlation as the entire variables between the qualitative variables in the ordinal scales by a mathematical formula, a method of introducing a “correlation index” and mainly calculating the correlation index will be described in this section B-2. However, it should be sufficiently noted that the “correlation index” referred to in the present specification is an index uniquely defined on the basis of the present disclosure, and is completely different from the “correlation index” having the same name described in other documents.

The correlation index (hereinafter, simply referred to as a “correlation index”) Z in the present disclosure is a value obtained by summing, over the entire one variable, a normalized value of a difference between an occupancy probability of an upper category and an occupancy probability of a lower category of one variable (for example, “explained variable”) between two consecutive categories of the other variable (for example, “explanatory variable”) between the two variables that are qualitative variables and are ordinal scales. Strictly speaking, in consideration of the fact that the number of samples of one variable in each category is not uniform, weighting according to the sum of the number of samples of each category is performed on the difference between the occupancy probability of the upper category and the lower upper occupancy probability.

A specific calculation formula of the correlation index Z will be described. The total number of categories of the explanatory variable is K (where K is an integer of 2 or more), and the number of samples in the k-th category (here, k is an integer satisfying 1≤k≤K) is nₖ. In addition, the total number of categories of the explained variable is M (where M is an integer of 2 or more), and the occupancy probability of the m-th category (here, m is an integer satisfying 1≤m≤M) of the explained variable in the k-th category of the explanatory variable is B_{m,k} (<0). In this case, the correlation index Z between the explanatory variable and the explained variable is calculated according to the following formulas (1) and (2).

$$[ Math . 1 ]$$

$$Z = {\sum }_{k = 2}^{K} \frac{{n}_{k} + {n}_{k - 1}}{\vert {n}_{k} - {n}_{k - 1} \vert + Δ} ( {\sum }_{m = 1}^{M / 2} \frac{{B}_{m , k - 1} - {B}_{m , k}}{{B}_{m , k} + {B}_{m , k - 1}} + {\sum }_{m = M / 2 + 1}^{M} \frac{{B}_{m , k} - {B}_{m , k - 1}}{{B}_{m , k} + {B}_{m , k - 1}} ) \qquad ( 1 )$$

$$[ Math . 2 ]$$

$$Z = {\sum }_{k = 2}^{K} \frac{{n}_{k} + {n}_{k - 1}}{\vert {n}_{k} - {n}_{k - 1} \vert + Δ} ( {\sum }_{m = 1}^{m < M / 2} \frac{{B}_{m , k - 1} - {B}_{m , k}}{{B}_{m , k} + {B}_{m , k - 1}} + {\sum }_{m > M / 2}^{M} \frac{{B}_{m , k} - {B}_{m , k - 1}}{{B}_{m , k} + {B}_{m , k - 1}} ) \qquad ( 2 )$$

When the total number M of the categories of the explained variable is an even number, the correlation index Z is calculated by dividing the explained variable into exactly two of the upper category and the lower category on the basis of the above formula (1). On the other hand, when the total number M of the categories of the explained variable is an odd number, the correlation index Z is calculated by dividing into two of the upper category and the lower category with an exactly intermediate category of the explained variable as a boundary on the basis of the above formula (2).

Note that Δ appearing on the right sides of the above formulas (1) and (2) is a positive fixed parameter. In the present embodiment, Δ is the total number of samples over all categories of the explanatory variable, and is calculated according to the following formula (3).

$$[ Math . 3 ]$$

$$Δ = {\sum }_{k = 1}^{K} {n}_{k} \qquad ( 3 )$$

The correlation index Z is a numerical value obtained by quantifying the relationship between the explanatory variable and the explained variable as the entire variables according to the above formula (1) or (2). When the correlation index Z is a large value, it indicates that the degree of correlation between the explanatory variable and the explained variable is strong. In addition, a positive value of the correlation index Z indicates that there is a positive correlation between the explanatory variable and the explained variable, and a negative value of the correlation index Z indicates that there is a negative correlation between the explanatory variable and the explained variable. The correlation index Z based on the above formulas (1) and (2) is designed so that the influence of a category having a large occupancy probability increases. A general correlation coefficient quantifies a correlation between two quantitative variables, whereas a correlation index Z defined in the present disclosure can quantify a correlation between two variables of qualitative variables and are ordinal scales.

In addition, in the process of calculating the correlation index Z of the entire variables, on the basis of the difference (this is also referred to as a “sub-correlation index Z_{sub}”) between the occupancy probability of the upper category and the occupancy probability of the lower category of the other variable between two consecutive categories k and category (k−1) of one variable, the relationship with the objective function in some categories of the explanatory variable described in the above section B-1 can also be quantified by the mathematical formula. Therefore, by detecting the positive and negative signs for each sub-correlation index Z_{sub}, it is possible to determine the relationship between variables (whether it is a positive correlation or a negative correlation) with a fine granularity between two consecutive categories instead of the entire variables, and it is also possible to detect that the relationship between variables is partially switched (that is, there is a tendency different from others in some conditions). That is, according to the present disclosure, it is possible to find nonlinearity such as a difference in the distribution of the explained variable only between two consecutive categories of a part of the explanatory variable.

The sub-correlation index Z_{sub} between two consecutive categories k and category (k−1) of the explanatory variable is calculated according to the following formulas (4) and (5). However, the following formula (4) is a calculation formula in a case where the total number M of categories of the explained variable is an even number, and the following formula (5) is a calculation formula in a case where the total number M of categories of the explained variable is an odd number.

$$[ Math . 4 ]$$

$${Z}_{sub} = \frac{{n}_{k} + {n}_{k - 1}}{\vert {n}_{k} - {n}_{k - 1} \vert + Δ} ( {\sum }_{m = 1}^{M / 2} \frac{{B}_{m , k - 1} - {B}_{m , k}}{{B}_{m , k} + {B}_{m , k - 1}} + {\sum }_{m = M / 2 + 1}^{M} \frac{{B}_{m , k} - {B}_{m , k - 1}}{{B}_{m , k} + {B}_{m , k - 1}} ) \qquad ( 4 )$$

$$[ Math . 5 ]$$

$${Z}_{sub} = \frac{{n}_{k} + {n}_{k - 1}}{\vert {n}_{k} - {n}_{k - 1} \vert + Δ} ( {\sum }_{m = 1}^{m < M / 2} \frac{{B}_{m , k - 1} - {B}_{m , k}}{{B}_{m , k} + {B}_{m , k - 1}} + {\sum }_{m > M / 2}^{M} \frac{{B}_{m , k} - {B}_{m , k - 1}}{{B}_{m , k} + {B}_{m , k - 1}} ) \qquad ( 5 )$$

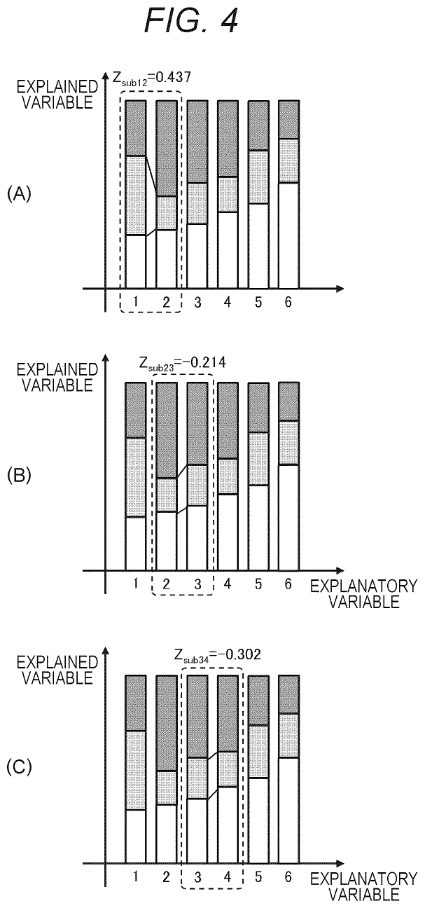

In FIG. 4, a method of calculating the sub-correlation index Z_{sub} for each pair of two consecutive categories of the explanatory variable and deriving the relationship between the variables using the conditional probability chart illustrated in FIG. 1 will be described. As illustrated, in a case where the explanatory variable is categorized in six stages of categories 1 to 6, the sub-correlation index Z_{sub} in a total of five category pairs of a pair of category 1 and category 2, a pair of category 2 and category 3, and . . . is calculated. As illustrated in FIG. 4(A), when the explanatory variable transitions from category 1 to category 2, the occupancy probability of category “high” of the explained variable increases, and the sub-correlation index Z_{sub12} is 0.437, that is, a positive value, which quantitatively indicates that it is positively correlated with the explained variable. Subsequently, as illustrated in FIG. 4(B), when the explanatory variable transitions from category 2 to category 3, the occupancy probability of category “high” of the explained variable decreases while category “low” increases, and the sub-correlation index Z_{sub23} is −0.214, that is, a negative value, which quantitatively indicates that it is negatively correlated with the explained variable. Further subsequently, as illustrated in FIG. 4(C), also when the explanatory variable transitions from category 3 to category 4, the occupancy probability of category “high” of the explained variable decreases and category “low” increases, and the sub-correlation index Z_{sub34} is −0.302, that is, a negative value, which quantitatively indicates that it is negatively correlated with the explained variable.

In this manner, it is possible to determine the relationship for each pair of categories as either positive correlation or negative correlation on the basis of the positive or negative sign of each sub-correlation index Z_{sub} calculated for each pair of two consecutive categories of the explanatory variable. Furthermore, on the basis of the appearance order of the positive and negative signs of the sub-correlation index Z_{sub}, as illustrated in the following (a) to (c), it is possible to determine whether there is a positive correlation, a negative correlation, or a non-linear correlation tendency between the explanatory variable and the explained variable as the entire variables.
(a) Positive correlation . . . All sub-correlation indexes Z_{sub} have positive sign
(b) Negative correlation . . . All sub-correlation indexes Z_{sub} have negative sign
(c) Non-linear . . . Sub-correlation indexes Z_{sub} with positive sign and negative sign are mixed in the entire variables

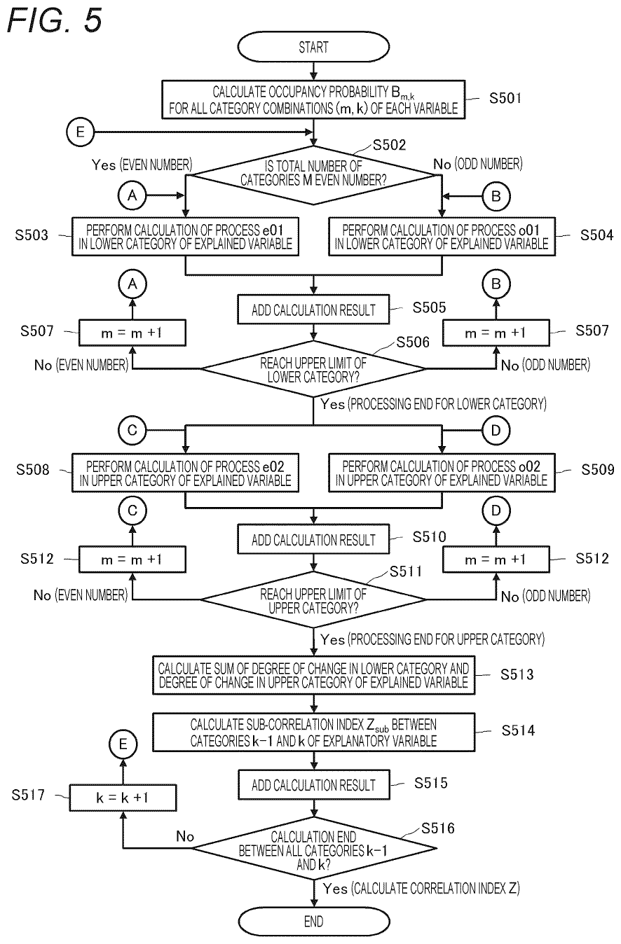

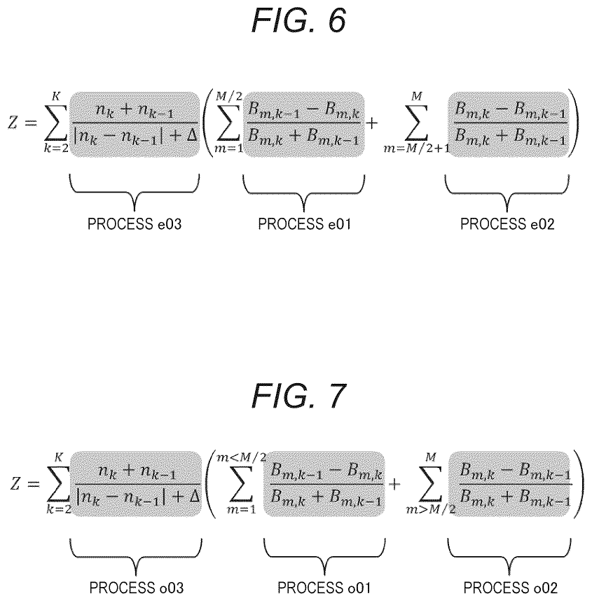

FIG. 5 illustrates a processing procedure for calculating the correlation index Z between the explanatory variable and the explained variable, which are both qualitative variables and are ordinal scales, in the format of a flowchart. Hereinafter, a processing procedure for calculating the correlation index Z using the above formulas (1) and (2) will be described in detail with reference to FIG. 5. However, for convenience of description, the calculation processing of each term on the right side of the above formula (1) in a case where the total number of categories M of the explained variable is an even number is set as processes e01, e02, and e03 as illustrated in FIG. 6, and similarly, the calculation processing of each term on the right side of the above formula (2) in a case where the total number of categories of the explained variable is an odd number is set as processes o01, o02, and o03 as illustrated in FIG. 7.

First, the occupancy probability B_{m,k} is calculated for all category combinations (m, k) of the explanatory variable and the explained variable (step S501).

Next, it is checked whether the total number of categories M of the explained variable is an even number or an odd number (step S502).

Here, in a case where the total number of categories M of the explained variable is an even number (Yes in step S502), the calculation of the process e01 is performed in each lower category (1≤m≤M/2) of the explained variable (step S503), and in a case where the total number of categories M of the explained variable is an odd number (No in step S502), the calculation of the process o01 is performed in each lower category (1≤m≤M/2) of the explained variable (step S504).

Both the process e01 and the process o01 are processes for a lower category of the explained variable. In steps S503 and S504, processing of calculating a change (B_{m,k-1}−B_{m,k}) between the occupancy B_{m,k} of the category k of the explanatory variable and the occupancy B_{m,k-1} of the previous category (k−1) is performed in the lower category m of the explained variable. However, in either case, the normalization is performed by dividing by the sum of the occupancy B_{m,k} of the category k and the occupancy B_{m,k-1} of the previous category (k−1).

In a case where the change (B_{m,k-1}−B_{m,k}) is positive, when the category of the explanatory variable increases between the consecutive categories k and (k−1) of the explanatory variable, the occupancy of the category m of the explained variable decreases (that is, the occupancy of the category m of the explained variable in the previous category (k−1) of the explanatory variable is larger), which means that there is a positive correlation in the lower category of the explained variable. On the other hand, in a case where the change (B_{m,k-1}−B_{m,k}) is negative, when the category of the explanatory variable increases between the consecutive categories k and (k−1) of the explanatory variable, the occupancy of the category m of the explained variable increases (that is, the occupancy of the category m of the explained variable in the previous category (k−1) of the explanatory variable is smaller), which means that there is a negative correlation in the lower category of the explained variable.

Then, the calculated change (B_{m,k-1}−B_{m,k})/(B_{m,k}+B_{m,k-1}) is added to the previous calculation result (step S505). Until the category m of the explained variable reaches the upper limit of the lower category (No in step S506), m is added by 1 (step S507), and the process returns to either step S503 and S504 and one of the process e01 and the process o01 is repeatedly performed to obtain the sum of the process e01 or the process o01 for all the lower categories of the explained variable.

When the category m reaches the upper limit of the lower category (Yes in step S506) and the sum of the processes e01 or o01 for all the lower categories of the explained variable is obtained, subsequently, in a case where the total number of categories M of the explained variable is an even number (Yes in step S502), the calculation of the process e02 is performed in each upper category of the explained variable (M/2≤m≤M) (step S508), and in a case where the total number of categories M of the explained variable is an odd number (No in step S502), the calculation of the process o02 is performed in each upper category of the explained variable (M/2<m≤M) (step S509).

Both the process e02 and the process o02 are processes for an upper category of the explained variable. In steps S508 and S509, processing of calculating a change (B_{m,k-1}−B_{m,k}) between the occupancy B_{m,k} of the category k of the explanatory variable and the occupancy B_{m,k-1} of the previous category (k−1) is performed in the upper category m of the explained variable. However, in either case, the normalization is performed by dividing by the sum of the occupancy B_{m,k} of the category k and the occupancy B_{m,k-1} of the previous category (k−1).

In a case where the change (B_{m,k-1}−B_{m,k}) is positive, when the category of the explanatory variable increases between the consecutive categories k and (k−1) of the explanatory variable, the occupancy of the category m of the explained variable increases (that is, the occupancy of the category m of the explained variable in the previous category (k−1) of the explanatory variable is smaller), which means that there is a positive correlation in the upper category of the explained variable. On the other hand, in a case where the change (B_{m,k-1}−B_{m,k}) is negative, when the category of the explanatory variable increases between the consecutive categories k and (k−1) of the explanatory variable, the occupancy of the category m of the explained variable decreases (that is, the occupancy of the category m of the explained variable in the previous category (k−1) of the explanatory variable is larger), which means that there is a negative correlation in the upper category of the explained variable.

Then, the calculated change (B_{m,k-1}−B_{m,k})/(B_{m,k}+B_{m,k-1}) is added to the previous calculation result (step S510). Until the category m reaches the upper limit of the upper category (No in step S511), m is added by 1 (step S512), and the process returns to either step S508 or S509 and one of the process e02 and the process o02 is repeatedly performed to obtain the sum of the process e02 or the process o02 for all the upper categories of the explained variable.

The sum of the process e01 or the process o01 for all the lower categories of the explained variable is the degree of change of the lower category of the explained variable between the category k and the category (k−1) of the explanatory variable. In addition, the sum of the process e02 or the process o02 for all the lower categories of the explained variable is the degree of change of the upper category of the explained variable between the category k and the category (k−1) of the explanatory variable. Next, the sum of the degree of change in the lower category of the explained variable and the degree of change in the upper category of the explained variable between the category k and the category (k−1) of the explanatory variable is calculated, and the pre-correction sub-correlation index Z_{sub} between the category k and the category (k−1) of the explanatory variable is obtained (step S513).

Then, as the process e03 and the process o03, the pre-correction sub-correlation index Z_{sub} is weighted by a coefficient whose value increases as the total number of samples (nₖ+nₖ₋₁) increases and as the change |nₖ−nₖ₋₁| in the number of samples decreases with respect to the number of samples nₖ in the category k of the explanatory variable and the number of samples nₖ₋₁ in the category (k−1) of the explanatory variable to obtain the sub-correlation index Z_{sub} (step S514).

Then, the calculated sub-correlation index Z_{sub} is added to the sum of the sub-correlation indexes Z_{sub} calculated so far (step S515). Until the process is completed for all the consecutive categories k and categories (k−1) (No in step S516), k is added by 1 (step S517), and the process returns to step S502 to repeatedly perform the calculation of the sub-correlation index Z_{sub} and the process of adding to the sum of the sub-correlation indexes Z_{sub} calculated so far. Finally, the sum of all the sub-correlation indexes Z_{sub}, that is, the correlation index Z for the entire variables can be calculated.

The processes e01 and o01 and the processes e02 and o02 will be supplementarily described. The positive or negative of the correlation index is calculated for the lower category of the explained variable in processes e01 and o01, and for the upper category of the explained variable in processes e02 and o02, so that the tendency of the correlation with the explanatory variable as the entire explained variable is emphasized. In a case where the positive correlation is strong (that is, in a case where the correlation index is a large positive value), the lower category of the explained variable tends to gradually decrease while the upper category tends to gradually increase (see, for example, FIG. 4(A)). On the other hand, in a case where the negative correlation is strong (that is, in a case where the correlation index is a large negative value), the lower category of the explained variable tends to gradually increase while the upper category tends to gradually decrease (see, for example, FIG. 4(C)).

The above formulas (1) and (2) are calculation formulas of the correlation index Z in consideration of the degree of change of both the lower category and the upper category of the explained variable. As a modification, it is also possible to find the correlation of the entire variables and the partial relationship of the variables by using the calculation formula of the correlation index considering only the degree of change of the lower category of the explained variable as illustrated in the following formulas (6) and (7) (where the formula (6) is a case where the total number of categories M of the explained variable is an even number, and the formula (7) is a case where M is an odd number), and the calculation formula of the correlation index considering only the degree of change of the upper category of the explained variable as illustrated in the following formulas (8) and (9) (where the formula (8) is a case where M is an even number, and the formula (9) is a case where M is an odd number).

$$[ Math . 6 ]$$

$$Z = {\sum }_{k = 2}^{K} \frac{{n}_{k} + {n}_{k - 1}}{\vert {n}_{k} - {n}_{k - 1} \vert + Δ} ( {\sum }_{m = 1}^{M / 2} \frac{{B}_{m , k - 1} - {B}_{m , k}}{{B}_{m , k} + {B}_{m , k - 1}} ) \qquad ( 6 )$$

$$[ Math . 7 ]$$

$$Z = {\sum }_{k = 2}^{K} \frac{{n}_{k} + {n}_{k - 1}}{\vert {n}_{k} - {n}_{k - 1} \vert + Δ} ( {\sum }_{m = 1}^{m < M / 2} \frac{{B}_{m , k - 1} - {B}_{m , k}}{{B}_{m , k} + {B}_{m , k - 1}} ) \qquad ( 7 )$$

$$[ Math . 8 ]$$

$$Z = {\sum }_{k = 2}^{K} \frac{{n}_{k} + {n}_{k - 1}}{\vert {n}_{k} - {n}_{k - 1} \vert + Δ} ( {\sum }_{m = M / 2 + 1}^{M} \frac{{B}_{m , k} - {B}_{m , k - 1}}{{B}_{m , k} + {B}_{m , k - 1}} ) \qquad ( 8 )$$

$$[ Math . 9 ]$$

$$Z = {\sum }_{k = 2}^{K} \frac{{n}_{k} + {n}_{k - 1}}{\vert {n}_{k} - {n}_{k - 1} \vert + Δ} ( {\sum }_{m > M / 2}^{M} \frac{{B}_{m , k} - {B}_{m , k - 1}}{{B}_{m , k} + {B}_{m , k - 1}} ) \qquad ( 9 )$$

Note that, in a case where the total number of categories M of the explained variable is an odd number, in the above formulas (2), (5), and (7), the lower category is set to 1≤m≤M/2 and the upper category is set to M/2<m≤M, and the exactly intermediate category of the explained variable is excluded from the calculation of the correlation index Z. As a reason, there is a case where an exactly intermediate category illustrates a tendency different from a change in the upper category and the lower category, and there is a case where there is no change in the intermediate category even if there is a positive or negative correlation tendency in each of the upper category and the lower category. The analysis of the relationship between the qualitative variables in the ordinal scales often focuses on a change in the upper category or a change in the lower category. The present disclosure proposes a method capable of calculating the correlation index Z in which a correlation tendency is further emphasized by excluding the influence of the intermediate category as described above.

In the summary for the section B, according to the present disclosure, a correlation between two variables that are qualitative variables and are ordinal scales can be expressed on the basis of numerical data called a correlation index Z. Furthermore, according to the present disclosure, nonlinearity between two variables can be found on the basis of the information of the sub-correlation index Z_{sub} obtained in the process of calculating the correlation index Z over the entire variables. That is, according to the present disclosure, unlike a case where nonlinearity is expressed using a visualization method such as a scatter diagram or a conditional probability chart, nonlinearity of a correlation between variables can be objectively found without depending on human visual judgment and without including an operation step by an analyst for confirmation (without being affected by an experienced person or a bias of an analyst).

Note that all variables to be subjected to multivariate analysis are not necessarily ordinal scales of qualitative variables, and quantitative variables and nominal scales of qualitative variables may be mixed. In such a case, the correlation index Z in the present disclosure can be calculated by converting another variable into an ordinal scale of a qualitative variable. For example, quantitative variables can be categorized in multiple stages with a predetermined order of magnitude, such as quartiles, to be transformed into ordinal scales of qualitative variables. In addition, the nominal scale may be converted into an ordinal scale by assigning an order and a magnitude relationship between names on the basis of a predetermined rule.

### C. System Configuration Example

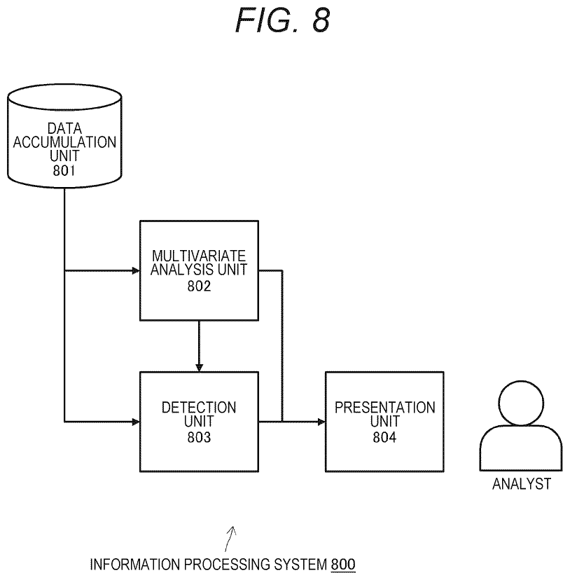

FIG. 8 schematically illustrates a functional configuration example of an information processing system 800 that performs multivariate analysis and processing of presenting an analysis result by applying the present disclosure. The illustrated information processing system 800 includes a data accumulation unit 801, a multivariate analysis unit 802, a detection unit 803, and a presentation unit 804.

The data accumulation unit 801 accumulates a large number of data to be subjected to multivariate analysis. The multivariate analysis unit 802 reads analysis data from the data accumulation unit 801 and performs data analysis using a multivariate analysis algorithm. The multivariate analysis unit 802 may estimate a highly accurate causal model from a large scale and various actual data using, for example, a learned model. The multivariate analysis unit 802 may perform multivariate analysis/causal analysis using CALC (registered trademark), which is an algorithm provided by Sony Computer Science Laboratories, Inc.

The detection unit 803 detects a combination of two variables having a characteristic relationship in multivariate analysis. Specifically, the detection unit 803 calculates the correlation index Z of the entire variables according to the processing procedure illustrated in FIG. 5 in a case where the two variables to be paired follow qualitative variables and ordinal scales. As a means by which the detection unit 803 obtains information of a variable, which is a qualitative variable and an ordinal scale, from many variables, examples include, for example, an analyst explicitly giving information before analysis or at the time of defining the variable, utilizing logic that automatically discriminates variables, and the like. In addition, a method (described above) of qualitatively converting a quantitative variable into an ordinal scale or converting a nominal scale into an ordinal scale may be used. Furthermore, the detection unit 803 may also calculate a mutual information amount MI between two variables.

Furthermore, in addition to calculating the correlation index Z of the entire variables, the detection unit 803 calculates a sub-correlation index Z_{sub} based on the degree of change in the occupancy probability of the upper category of the explained variable and the degree of change in the occupancy probability of the lower category between two consecutive categories of one variable (explanatory variable) for all two consecutive categories. For example, as illustrated in FIG. 1, in a case where the explanatory variable is categorized into six stages of categories 1 to 6, a sub-correlation index Z_{sub} in a total of five category pairs of a pair of category 1 and category 2, a pair of category 2 and category 3, and . . . is calculated.

Then, on the basis of the appearance order of positive and negative signs of the sub-correlation index Z_{sub}, the detection unit 803 determines, as the entire variables, which one of a positive correlation, a negative correlation, and a non-linear correlation tendency between the explanatory variable and the explained variable, that is, a characteristic relationship between the variables, as illustrated in the following (a) to (c).
(a) Positive correlation . . . All sub-correlation indexes Z_{sub} have positive sign
(b) Negative correlation . . . All sub-correlation indexes Z_{sub} have positive sign
(c) Non-linear . . . Sub-correlation indexes Z_{sub} with positive sign and negative sign are mixed in the entire variables

In a case where there are many variables to be subjected to multivariate analysis, if the calculation processing of the correlation index Z is performed for all combinations of two variables, the calculation amount becomes enormous. Therefore, the calculation of the correlation index Z may be performed only for a pair of two variables limited to a combination of two variables selected by being applied to a filter. For example, only a pair of variables connected by an edge in the causal model output by the multivariate analysis unit 802 may be set as a processing target of the detection unit 803, or only a pair of variables connected by a further selected edge instead of all edges may be set as a processing target of the detection unit 803. Alternatively, a pair of two variables explicitly designated by the analyst at the time of defining the variable before analysis or a pair of two variables connected by an edge designated on the causal model after analysis may be set as the processing target of the detection unit 803.

The presentation unit 804 presents the information regarding the characteristic relationship between the two variables detected by the detection unit 803 using a visualization tool such as a display screen. The presentation unit 804 may display information regarding the characteristic relationship between the two variables using, for example, the causal graph generated by the multivariate analysis unit 802. Furthermore, the presentation unit 804 may visualize and express the information regarding the characteristic relationship between the two variables using a format such as a conditional probability chart, a conditional probability table, or a scatter diagram (correlation graph).

Note that the information processing system 800 may include a physically single information processing apparatus including a personal computer (PC) or the like, or may include a plurality of information processing apparatuses. For example, each of the multivariate analysis unit 802, the detection unit 803, and the presentation unit 804 may be configured by one information processing apparatus. Furthermore, the presentation unit 804 may include a portable multifunctional information terminal such as a smartphone or a tablet, and may visualize and present information regarding a characteristic relationship between variables at a location remote from the information processing apparatus constituting the multivariate analysis unit 802 and the detection unit 803.

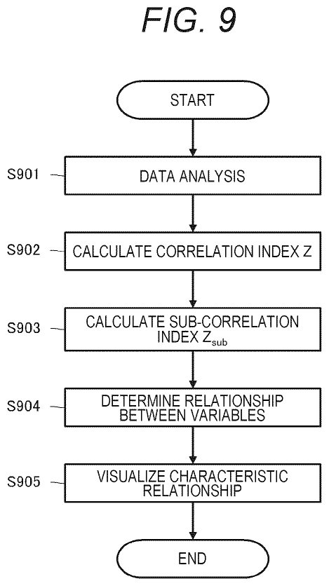

FIG. 9 schematically illustrates a procedure of performing the multivariate analysis and the processing of presenting the analysis result in the information processing system 800 in the format of a flowchart. Hereinafter, the operation of the information processing system 800 will be described with reference to FIG. 9.

First, the multivariate analysis unit 802 reads the analysis data from the data accumulation unit 801, and performs data analysis using the multivariate analysis algorithm (step S901).

Next, the detection unit 803 detects a combination of two variables having a characteristic relationship in multivariate analysis (step S902). Specifically, the detection unit 803 calculates the correlation index Z of the entire variables according to the processing procedure illustrated in FIG. 5 in a case where the two variables to be paired follow qualitative variables and ordinal scales.

Furthermore, in addition to calculating the correlation index Z of the entire variables, the detection unit 803 calculates a sub-correlation index Z_{sub} based on the degree of change in the occupancy probability of the upper category of the explained variable and the degree of change in the occupancy probability of the lower category between two consecutive categories of one variable (explanatory variable) for all two consecutive categories (step S903).

Further, the detection unit 803 determines whether there is a positive correlation, a negative correlation, or a non-linear correlation tendency between the explanatory variable and the explained variable as the entire variables, that is, a characteristic relationship between the variables, on the basis of the appearance order of the positive and negative signs of the sub-correlation index Z_{sub} (step S904).

Then, the presentation unit 804 presents the information regarding the characteristic relationship between the two variables detected by the detection unit 803 using a visualization tool such as a display screen (step S905). The presentation unit 804 may display information regarding the characteristic relationship between the two variables using, for example, the causal graph generated by the multivariate analysis unit 802.

Next, a method for visualizing the information regarding the characteristic relationship between the two variables in the presentation unit 804 will be described.

FIG. 10 illustrates a display example of visualizing information regarding a characteristic relationship between two variables using a causal graph. The causal graph is a graphical model in which variables (or some variables) V₁, V₂, . . . to be analyzed are set as nodes, and nodes having a causal relationship are connected by edges. The edge is an oriented edge including an arrow from the explanatory variable to the explained variable. In the example illustrated in FIG. 10, whether or not the relationship between the two variables is characteristic is expressed by the thickness of the edge. In addition, instead of changing the thickness of the edge (alternatively, in addition to the expression by the thickness of the edge), the relationship between the two variables may be visualized using the shading or luminance of the edge. The characteristic relationship between two variables includes, for example, a large mutual information amount, a strong correlation (positive correlation or negative correlation), a non-linear correlation, or the like. According to the visualization method as illustrated in FIG. 9, the analyst can more efficiently find a relationship between variables to be focused on when having an overview on the causal graph, and can reach a characteristic relationship without checking conditional probability charts or the like between all variables.

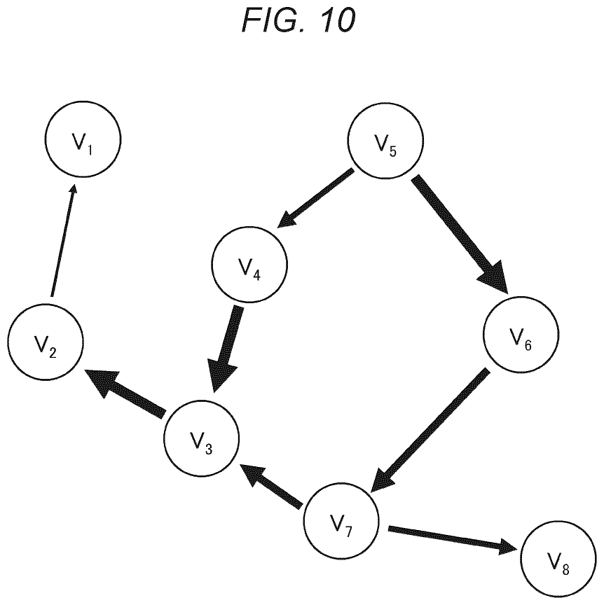

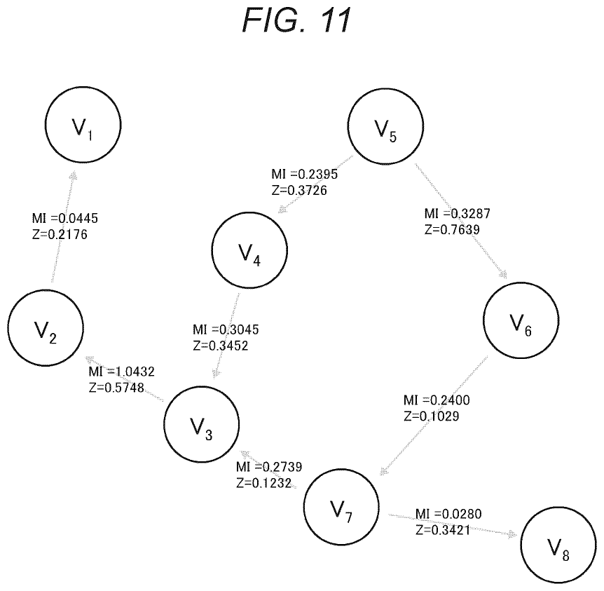

FIG. 11 illustrates another display example of visualizing information regarding a characteristic relationship between two variables using a causal graph. In the example illustrated in FIG. 11, the mutual information amount MI and the correlation index Z between two variables connected at each edge on the causal graph are displayed. In particular, the mutual information amount MI and the correlation index Z may be displayed in a highlighted manner by changing a character font, a character size, a color, a thickness, or the like at an edge between variables whose relationship is to be emphasized. Therefore, by confirming the mutual information amount MI and the correlation index Z of each edge on the causal graph, the analyst can efficiently and reliably find two variables having a high degree of mutual dependence and two variables having a strong correlation. Note that it is not necessary to display the mutual information amount MI and the correlation index Z on all the edges on the causal graph, and at least one value of the mutual information amount MI or the correlation index Z may be displayed limited to a large edge.

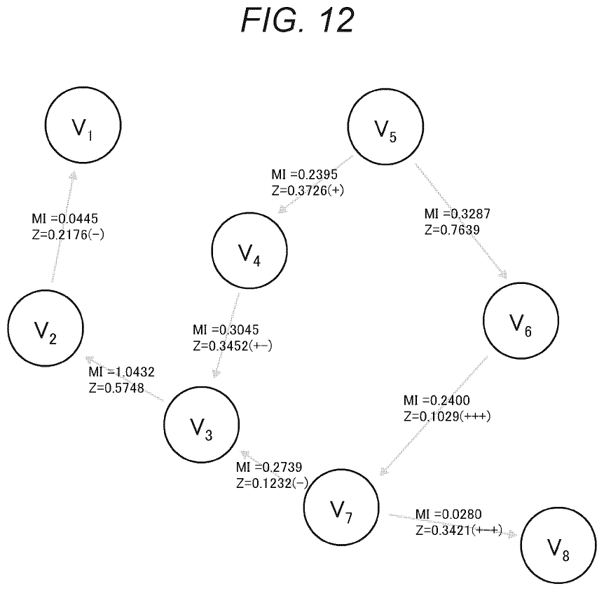

FIG. 12 illustrates still another display example of visualizing information regarding a characteristic relationship between two variables using a causal graph. In the example illustrated in FIG. 12, a type of correlation between two variables is further displayed on each edge on the causal graph together with the mutual information amount MI and the correlation index Z between the two variables connected at the edge. The type of correlation includes, for example, three types of “positive correlation” in which all the sub-correlation indexes Z_{sub} are positive signs, “negative correlation” in which all the sub-correlation indexes Z_{sub} are positive signs, and “non-linear” in which the sub-correlation indexes Z_{sub} of positive and negative signs are mixed in the entire variables. In the example illustrated in FIG. 12, a simple positive correlation for the entire variables is indicated by the symbol ‘(+)’, a simple negative correlation for the entire variables is indicated by the symbol ‘(−)’, and non-linear correlation for the entire variables is indicated by the symbol ‘(+−)’. Although it is not possible to visualize the relationship between the characteristic variables of non-linearity only by displaying the mutual information amount MI and the correlation index Z as in the example illustrated in FIG. 11, it is possible to express the non-linear relationship in an easy-to-understand manner for the analyst according to the example illustrated in FIG. 12. As an evolution form, non-linearity may not be collectively expressed by the same symbol ‘(+−)’, but a sequence of positive and negative signs of the sub-correlation index Z_{sub} for each pair of two consecutive categories may be visualized using the symbol ‘(+−++− . . . )’. That is, according to the visualization method as illustrated in FIG. 12, the analyst can more efficiently find a non-linear relationship between variables when having an overview on the causal graph, and can reach a characteristic relationship without confirming conditional probability charts or the like between all variables.

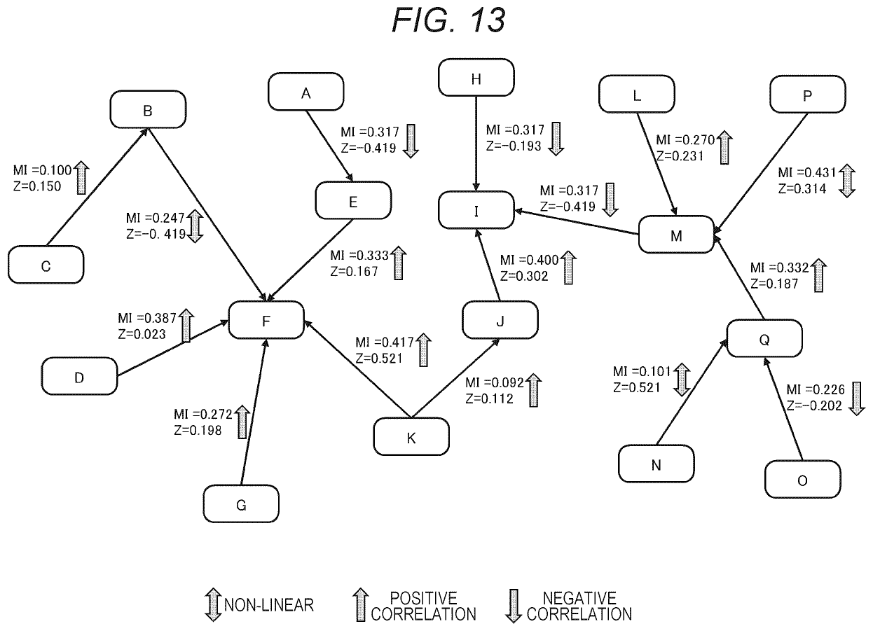

FIG. 13 illustrates a display example in which the type of correlation between two variables is visualized using an arrow icon instead of symbols such as ‘(+)’, ‘(−)’, and ‘(+−)’ as a modification of FIG. 12. In FIG. 13, an upward arrow icon is attached to an edge between variables having a simple positive correlation, a downward arrow icon is attached to an edge between variables having a simple negative correlation, and a bidirectional arrow icon is attached to an edge between variables having a non-linear relationship, so that the relationship between the variables can be understood at a glance and displayed in a highlighted manner. The icon of the bidirectional arrow can notify the analyst that there is a non-linear relationship between the two variables, that is, there is a state different from the tendency of the entire variables, and can provide a trigger to focus on the relationship between the two variables. In the example illustrated in FIG. 13, the analyst can easily focus on the edges of B-F, P-M, and N-Q of the non-linear relationship that can be said to be a characteristic relationship in the causal graph. It is considered effective to apply such a visualization method to a causal graph in a case where there are many variables.

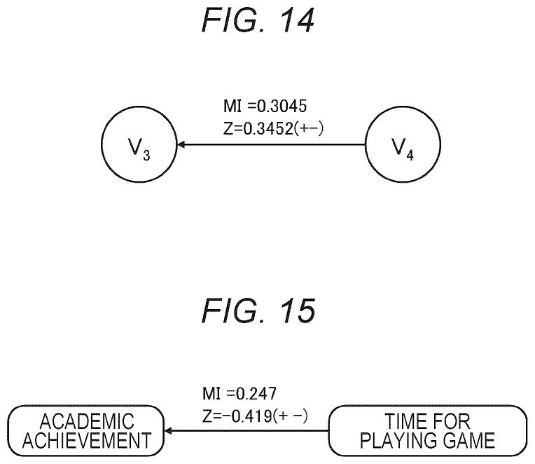

FIG. 14 illustrates a display example of visualizing information regarding the relationship between two variables V₃ and V₄ on a graph including nodes corresponding to the two variables for which the characteristic relationship has been detected and an edge connecting the nodes, instead of the causal graph. In the example illustrated in FIG. 14, similarly to the example illustrated in FIG. 12, the mutual information amount MI between variables, the correlation index Z, and a symbol ‘(+−)’ indicating the type of correlation are displayed on the edge. According to the visualization method as illustrated in FIG. 14, the analyst can quickly confirm the content of the characteristic relationship between the variables while saving time and effort to search for a pair of variables having a characteristic relationship from nodes of many variables.

To summarize the above, according to the present disclosure, the presentation unit 804 can present a pair of variables having a characteristic relationship among many variables and information regarding the characteristic relationship between the variables to the analyst by the visualization method illustrated in any one of FIGS. 10 to 14, for example. In addition, by visualizing the characteristic relationship between variables, it is possible to reduce oversight of insights by an analyst with low skill, an analyst's misunderstanding, or the like.

### D. Example (1)

In this section D, a first example in which the present disclosure is applied to data analysis in the educational field will be described.

It is assumed that the data accumulation unit 801 holds data such as attribute data indicating the age, gender, and the like of a child student, questionnaire data regarding a lifestyle answered by the child student, and a result of an academic achievement test indicating an academic achievement of the child student in a format associated with each child student. Then, the multivariate analysis unit 802 reads such analysis data from the data accumulation unit 801, performs analysis to infer a causal relationship that searches for a factor affecting the academic achievement of the child students, and obtains a causal graph representing a causal relationship between variables. Alternatively, the causal graph may be created by the analyst on the basis of his/her knowledge from the analysis result by the multivariate analysis unit 802, or may be created using both the estimation from the data and the knowledge of the analyst.

FIG. 15 illustrates a graph in which a node of “time for playing a game (regularly)”, which is one of variables (explanatory variable) being a factor of affecting the academic achievement, is connected to a node of a variable (explained variable) indicating the “academic achievement” by an oriented edge (arrow). In the illustrated example, a node of “time for playing a game” as an explanatory variable and a node of “academic achievement” as an explained variable are connected by an oriented edge (arrow), and the numerical value of the mutual information amount MI and the numerical value of the correlation index Z between these two variables are displayed on the edge. Furthermore, a symbol ‘(+−)’ indicating a non-linear relationship between the two variables is displayed after the correlation index Z. The notation method of the relationship between variables is as described above with reference to FIG. 12.

The detection unit 803 calculates the numerical value of the mutual information amount MI between the two variables and the numerical value of the correlation index Z, and determines the relationship (whether it is a positive correlation, a negative correlation, or non-linear) between the two variables on the basis of the appearance order of the positive and negative signs of the sub-correlation index Z_{sub}. Then, the presentation unit 804 displays a graph visualizing the result obtained by the detection unit 803 on the screen as illustrated in FIG. 15 and presents the graph to the analyst.

In the display example illustrated in FIG. 15, the strength of the relationship between variables (mutual information amount MI) and the correlation index Z having a negative value are presented. From such visualized data, it is possible to convey to the analyst that the overall tendency of the relationship between the two variables is negative correlation, that is, the longer the time for playing a game is, the smaller the number of child students with high academic achievement tends to be. In addition, by adding a symbol ‘(+−)’ after the correlation index Z, it is possible to further notify the analyst that there is a non-linear relationship between the two variables, that is, there is a state different from the tendency of the entire variables, and to provide a trigger to focus on the relationship between the two variables.

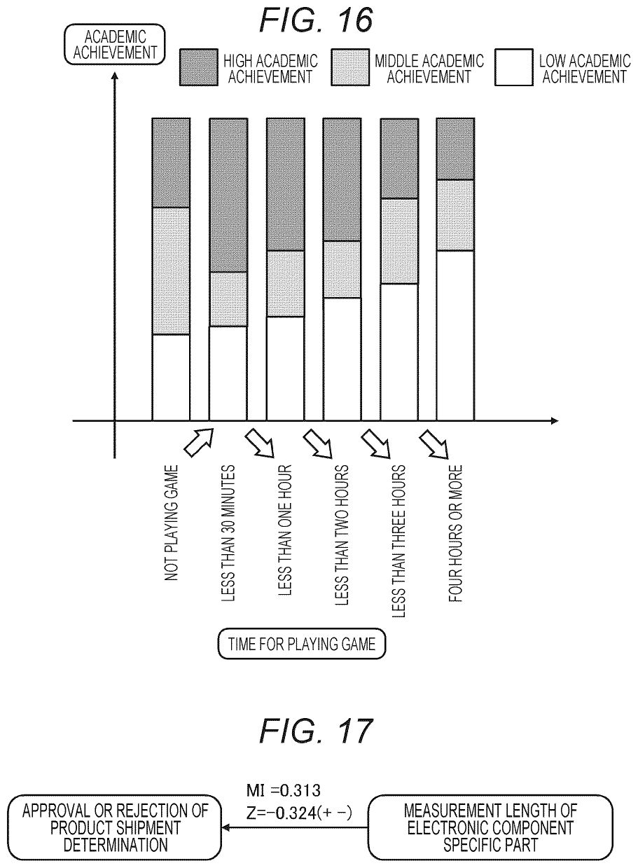

FIG. 16 illustrates a conditional probability chart between two variables of “academic achievement” and “time for playing a game”. In addition to the graph representation illustrated in FIG. 15, the presentation unit 804 may further present a conditional probability chart between the two variables for which the non-linear relationship has been determined by the detection unit 803. The presentation unit 804 may display the conditional probability chart on the screen in response to the request of the analyst, or may automatically display the conditional probability chart on the screen. Furthermore, the presentation unit 804 may present a scatter diagram (correlation graph) between these two variables instead of the conditional probability chart (alternatively, in combination with the conditional probability chart). In the conditional probability chart illustrated in FIG. 16, a positive correlation is represented by an upper right arrow, and a negative correlation is represented by a lower right arrow as features related to the relationship with the explained variable “academic achievement” between the categories of the explanatory variable “time for playing a game”. However, in addition to the arrow, the probability transition of the explained variable accompanying the state transition of the explanatory variable may be expressed in a visualized manner by a symbol such as +− or color-coding. By presenting this conditional probability chart, the analyst can focus on the portion where the direction of the arrow is switched, and easily notice that among the child students who do not play the game and the child students who play the game for less than 30 minutes, there are more child students with higher academic achievement in the child students who play the game for less than 30 minutes, and there is a feature opposite to the relationship with the academic achievement in the case of playing the game for 30 minutes or more.

In the conditional probability chart illustrated in FIG. 16, when only the child students in the category with the “low” academic achievement are focused on, there is a positive correlation tendency that the number of child students with low academic achievement increases as the time to play the game increases. Due to the color arrangement of the chart, the experience and bias of the analyst, and the like, there is a possibility that the overall tendency is erroneously recognized from partial tendencies, and the characteristic relationship that “there are more child students with higher academic achievement in the child students who play the game for less than 30 minutes” is overlooked. On the other hand, according to the present disclosure, it is possible to calculate the correlation index Z focusing on the change in the distribution of both the lower category (low academic achievement) and the upper category (high academic achievement) of the explained variable and present an objective tendency. Furthermore, according to the present disclosure, since the feature regarding the relationship with the explained variable (academic achievement) between each category of the explanatory variable “time for playing a game” is emphasized and visualized, the analyst can derive the relationship between a part of the explanatory variable and the explained variable by focusing on the change in the occupancy probability of each category of the explained variable for each pair of two consecutive categories of the explanatory variable, and easily notices the characteristic relationship that “there are more child students with higher academic achievement in the child students who play the game for less than 30 minutes” regardless of the difference in experience, bias, and the like. As illustrated in FIG. 16, by displaying an upper right arrow in the section of the explanatory variable that is positively correlated and a lower right arrow in the section of the explanatory variable that is negatively correlated, the analyst can more easily notice the characteristic relationship between the two variables.

### E. Example (2)

In this section E, a second example in which the present disclosure is applied to data analysis related to the manufacturing field, particularly the manufacturing of electronic components will be described.

It is assumed that the data accumulation unit 801 holds data such as a result of the final shipment determination of an electronic component, a voltage magnitude of a certain part, a measurement length in a manufacturing process in the middle of another part, and a line ID indicating a line in which the electronic component is manufactured in a format associated with a serial number of each electronic component. Then, the multivariate analysis unit 802 reads such analysis data from the data accumulation unit 801, performs an analysis to infer a causal relationship that searches for a factor affecting the final shipment determination of the electronic component, and obtains a causal graph representing a causal relationship between variables. Alternatively, the causal graph may be created by the analyst on the basis of his/her knowledge from the analysis result by the multivariate analysis unit 802, or may be created using both the estimation from the data and the knowledge of the analyst. In this analysis, it is known that there is a non-linear and non-monotonous relationship between the measurement length and the quality of the product, and it is assumed that the measurement length data is previously categorized into four stages using a quartile in order to express the non-monotonicity and nonlinearity.

FIG. 17 illustrates a graph in which a node of a variable (explained variable) indicating “approval or rejection of product shipment determination” is connected to a node of “measurement length of electronic component specific part” which is one of variables (explanatory variable) being a factor affecting the approval or rejection of product shipment determination with an edge. In the illustrated example, a node of “measurement length of electronic component specific part” as an explanatory variable and a node of “approval or rejection of product shipment determination” as an explained variable are connected by an oriented edge (arrow), and a numerical value of the mutual information amount MI and a numerical value of the correlation index Z between these two variables are displayed on the edge. Furthermore, a symbol ‘(+−)’ indicating a non-linear relationship between the two variables is displayed after the correlation index Z. The notation method of the relationship between variables is as described above with reference to FIG. 12.

The detection unit 803 calculates the numerical value of the mutual information amount MI between the two variables and the numerical value of the correlation index Z, and determines the relationship (whether it is a positive correlation, a negative correlation, or non-linear) between the two variables on the basis of the appearance order of the positive and negative signs of the sub-correlation index Z_{sub}. Then, the presentation unit 804 displays a graph visualizing the result obtained by the detection unit 803 on the screen as illustrated in FIG. 17 and presents the graph to the analyst.

In the display example illustrated in FIG. 17, the strength of the relationship between variables (mutual information amount MI) and the correlation index Z having a positive value are presented. From such visualized data, it is possible to notify the analyst that the overall tendency of the relationship between the two variables is a positive correlation, that is, the longer the measurement length of the electronic component specific part is, the more products determined to be non-defective by shipment tend to be. In addition, by adding a symbol ‘(+−)’ after the correlation index Z, it is possible to further notify the analyst that there is a non-linear relationship between the two variables, that is, there is a state different from the tendency of the entire variables, and to provide a trigger to focus on the relationship between the two variables.

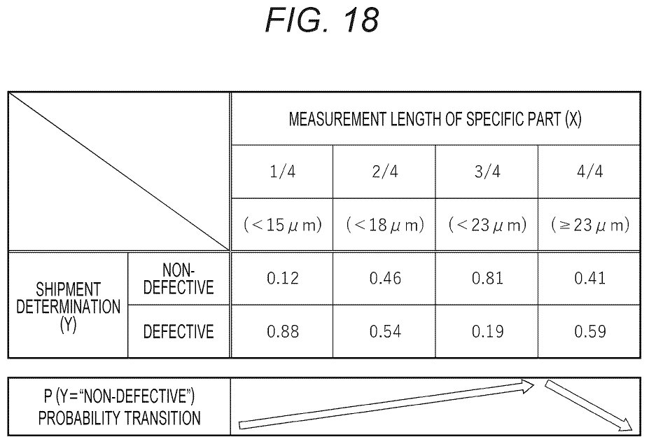

FIG. 18 illustrates a conditional probability table between two variables of “measurement length of electronic component specific part” and “approval or rejection of product shipment determination”. In addition to the graph representation illustrated in FIG. 17, the presentation unit 804 may further present a conditional probability table between the two variables for which the non-linear relationship has been determined by the detection unit 803, or may automatically display the conditional probability table on the screen. Furthermore, the presentation unit 804 may present a scatter diagram (correlation graph) between these two variables instead of the conditional probability table (alternatively, in combination with the conditional probability table). In the conditional probability table illustrated in FIG. 18, the distribution of the upper category “non-defective” and the lower category “defective” of the explained variable “approval or rejection of product shipment determination” in each category in which the explanatory variable “measurement length of electronic component specific part” is divided into four stages by quartile is illustrated. In the conditional probability table illustrated in FIG. 18, a positive correlation is represented by an upper right arrow, and a negative correlation is represented by a lower right arrow as features related to the relationship with the explained variable “approval or rejection of product shipment determination” between the categories of the explanatory variable “measurement length of electronic component specific part”. However, in addition to the arrow, the probability transition of the explained variable accompanying the state transition of the explanatory variable may be expressed in a visualized manner by a symbol such as +− or color-coding. By presenting the conditional probability table and the probability transition, the analyst can easily notice that there is a positive correlation in which the possibility that the “approval or rejection of product shipment determination” is determined as “non-defective” increases as the measurement length increases from the bottom to the third category of the “measurement length of electronic component specific part”, and that the correlation turns negative in the fourth category from the bottom of the “measurement length of electronic component specific part”. Therefore, the analyst can reach a conclusion that the yield of the product is the highest when the measurement length of the electronic component is controlled in the range of the quartile (18 to 23 μm in this example) in which the possibility that the shipment determination is determined to be non-defective in the positive correlation is the highest.

### F. Apparatus Configuration

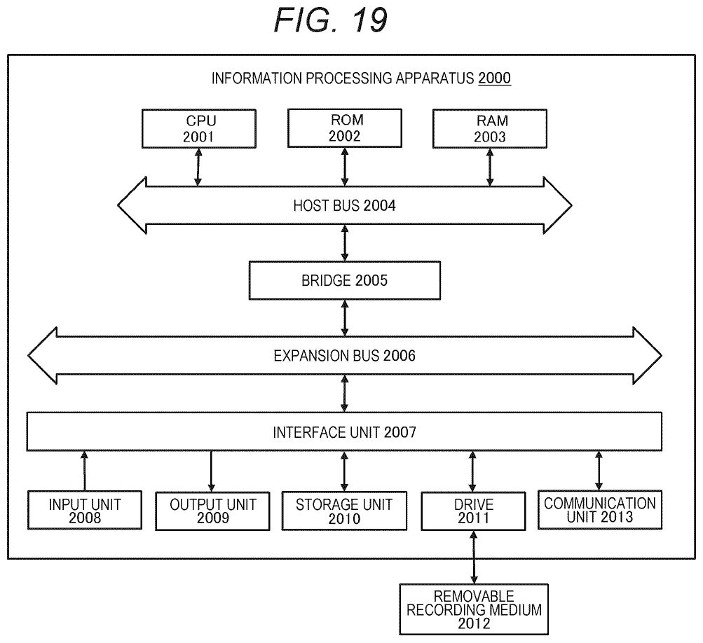

FIG. 19 illustrates a configuration example of an information processing apparatus 2000 applied to the information processing system 800. The information processing apparatus 2000 is configured by, for example, a PC or the like, and the entire information processing system 800 may be configured by one apparatus, or each of the multivariate analysis unit 802, the detection unit 803, and the presentation unit 804 may be configured by one information processing apparatus 2000.

The information processing apparatus 2000 illustrated in FIG. 19 includes a central processing unit (CPU) 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 functions as an arithmetic processing apparatus and a control apparatus, and controls overall operation of the information processing apparatus 2000 according to various programs. The ROM 2002 stores programs (basic input/output system or the like) and calculation parameters used by the CPU 2001 in a nonvolatile manner. The RAM 2003 is used to load a program to be used in execution of the CPU 2001 and temporarily store parameters such as work data that appropriately changes during execution of a program. Examples of the program loaded into the RAM 2003 and executed by the CPU 2001 include various application programs, an operating system (OS), and the like.

The CPU 2001, the ROM 2002, and the RAM 2003 are interconnected by the host bus 2004 including a CPU bus or the like. Then, the CPU 2001 operates in conjunction with the ROM 2002 and the RAM 2003 to execute various application programs under an execution environment provided by the OS, thereby enabling various functions and services to be implemented. In a case where the information processing apparatus 100 is a PC, the OS is, for example, Windows of Microsoft Corporation or Unix. In a case where the information processing apparatus 2000 is an information terminal such as a smartphone or a tablet, the OS is, for example, iOS of Apple Inc. or Android of Google Inc. In addition, the application program includes a multivariate analysis application, a detection application that detects a combination of two variables having a characteristic relationship in the multivariate analysis, and a presentation application that presents information regarding a characteristic relationship between the two variables.

The host bus 2004 is connected to the expansion bus 2006 via the bridge 2005. The expansion bus 2006 is, for example, a peripheral component interconnect (PCI) bus or PCI Express, and the bridge 2005 is based on the PCI standard. Then, the information processing apparatus 2000 does not necessarily have a configuration in which circuit components are separated by the host bus 2004, the bridge 2005, and the expansion bus 2006, and thus may be configured in such a way that almost all circuit components are implemented by being interconnected using a single bus (not illustrated).

The interface unit 2007 connects peripheral apparatuses such as the input unit 2008, the output unit 2009, the storage unit 2010, the drive 2011, and the communication unit 2013 according to the standard of the expansion bus 2006. However, all of the peripheral apparatuses illustrated in FIG. 19 are not necessarily essential, and the information processing apparatus 2000 may further include another peripheral apparatus (not illustrated). Furthermore, the peripheral apparatus may be built in the main body of the information processing apparatus 2000, or some peripheral apparatuses may be externally connected to the main body of the information processing apparatus 2000.

The input unit 2008 includes an input control circuit that generates an input signal on the basis of an input from a user to output the input signal to the CPU 2001, and the like. In a case where the information processing apparatus 2000 is a PC, the input unit 2008 may include a keyboard, a mouse, and a touch panel, and may further include a camera and a microphone. Further, in a case where the information processing apparatus 2000 is an information terminal such as a smartphone or a tablet, the input unit 2008 is, for example, a touch panel, a camera, or a microphone, and may further include another mechanical operator such as a button.

The output unit 2009 includes, for example, a display apparatus such as a liquid crystal display (LCD) apparatus, an organic electro-luminescence (EL) display apparatus, and a light emitting diode (LED). As in the present embodiment, in a case where multivariate analysis is performed on the information processing apparatus 2000, a network diagram such as a causal graph derived on the basis of a multivariate analysis result and information regarding a characteristic relationship between two variables are presented using a display apparatus. Furthermore, the output unit 2009 may include an audio output apparatus such as a speaker and a headphone, and output at least a part of a message to the user displayed on the UI screen as an audio message.

The storage unit 2010 stores files such as programs (application, OS, or the like) to be executed by the CPU 2001 and various pieces of data. The storage unit 2010 may function as, for example, the data accumulation unit 801 and accumulate a large number of data to be subjected to multivariate analysis. Although the storage unit 2010 includes, for example, a mass storage apparatus such as a solid state drive (SSD) or a hard disk drive (HDD), it may include an external storage apparatus.

A removable storage medium 2012 is a cartridge-type storage medium such as a microSD card, for example. The drive 2011 performs reading and writing operations on a removable storage medium 113 loaded therein. The drive 2011 outputs data read from the removable recording medium 2012 to the RAM 2003 and the storage unit 2010, and writes data on the RAM 2003 and the storage unit 2010 to the removable recording medium 2012.

The communication unit 2013 is a device that performs wireless communication such as Wi-Fi (registered trademark), Bluetooth (registered trademark), or a cellular communication network such as 4G or 5G. Furthermore, the communication unit 2013 may include a terminal such as a universal serial bus (USB) or a high-definition multimedia interface (HDMI (registered trademark)), and may further include a function of performing data communication with a USB device such as a scanner or a printer, a display, or the like.

### G. Summary

Finally, advantages of the present disclosure and effects brought by the present disclosure will be summarized.

The present disclosure can be applied to visualizing and expressing relationships between variables in multivariate analysis. According to the present disclosure, it is possible to search for a characteristic relationship between two variables that are qualitative variables and are ordinal scales, and visualize and express the characteristic relationship on a network diagram such as a causal model expressed by nodes and edges. In addition, the visualizing expression method according to the present disclosure is not necessarily limited to graph representation using a network diagram or the like. A case is also assumed where two variables in the ordinal scales having a characteristic relationship are not directly connected by an edge on the network diagram. In such a case, the characteristic relationship between the two variables may be expressed by a notation method other than the edge, or the characteristic relationship between the two variables may be visualized and expressed by a method other than the network diagram.

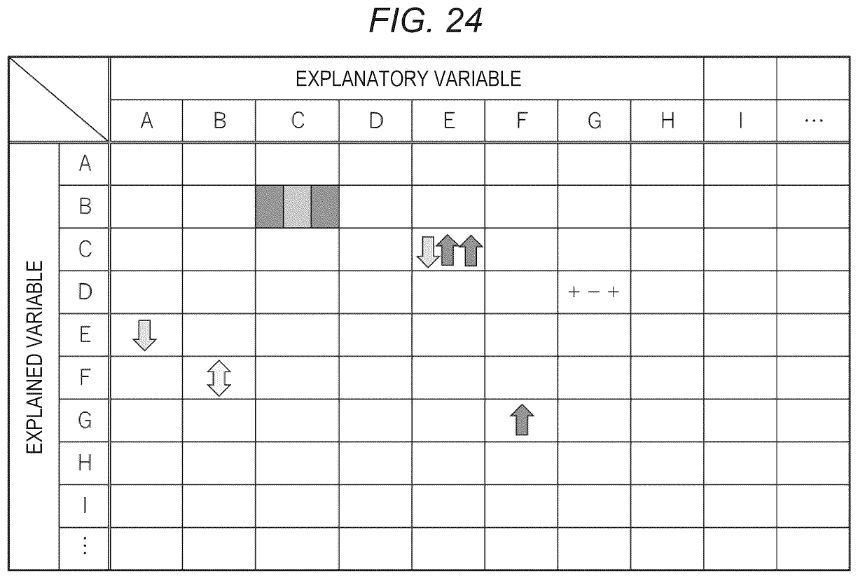

For example, a large number of variables to be subjected to multivariate analysis may be arranged in a table format or a matrix format, and information regarding a relationship between two variables may be displayed for each combination of variables, or a place where variables having a characteristic relationship intersect may be displayed in a heat map to call attention of an analyst. FIG. 23 illustrates an example of a table illustrating a relationship between two variables for each combination of variables in the format of a list. Furthermore, FIG. 24 illustrates an example of a table illustrating a relationship between two variables for each combination of variables in the format of a matrix. In FIGS. 23 and 24, an upward arrow or a “+” symbol is indicated in a case where the relationship between two variables is a positive correlation as the entire variables, and a downward arrow or a “−” symbol is indicated in a case where the relationship is a negative correlation as the entire variables. In addition, in a case where the relationship between two variables is non-linear, that is, in a case where the correlation with the explained variable changes due to the state transition of the explanatory variable, the transition of the correlation is expressed by an up-down arrow, a sequence of up and down arrows or +− symbols indicating the correlation for each state transition, division in a cell, color-coding corresponding to the correlation, and the like. According to the table format visualizing expression as illustrated in FIGS. 23 and 24, the characteristic relationship can be presented even between two variables that are not directly connected by an edge in the network diagram.

In any visualizing expression method such as a network diagram, a table format, or a matrix format, an analyst can efficiently search for a characteristic relationship from among relationships of many variables and can grasp an unexpected relationship between variables.

According to the present disclosure, in a relationship between an explanatory variable and an explained variable, a change in distribution of the explained variable in two consecutive categories of the explanatory variable can be quantified by a mathematical formula to derive a positive correlation or a negative correlation between the two categories. Furthermore, according to the present disclosure, it is possible to determine whether or not a positive correlation, a negative correlation, or a non-linear relationship is included in the entire transition of the category of the explanatory variable, and for example, visualize and express the relationship on a network diagram. Furthermore, according to the present disclosure, it is possible to quantify a tendency such as the strength of a positive correlation or a negative correlation as the entire variables on the basis of a numerical value obtained by quantifying a change in the distribution of the explained variable in two consecutive categories of the explanatory variable.

Therefore, the analyst can efficiently find a relationship between variables to be more focused on by having an overview the analysis result visualized and expressed by the present disclosure. The analyst can reach the characteristic relationship between the variables without confirming the conditional probability chart or the conditional probability table between all the variables, or by being guided by the information regarding the probability transition of the explained variable accompanying the state transition of the explanatory variable visualized and expressed in the form accompanying the conditional probability chart or the conditional probability table.

As described in the above section D, in a case where the present disclosure is applied to data analysis in the educational field, the relationship between the two variables of “time for playing a game” and “academic achievement” does not fall under a simplistic interpretation that there is a possibility of increasing the academic achievement by reducing the time for playing a game, and it becomes easy to find a relationship in which the academic achievement of child students who play a game is slightly higher than that of child students who do not play a game at all. The analyst can further continue to search for factors behind such relationships to increase the likelihood of obtaining more meaningful analysis results.

According to the present disclosure, it is possible to reduce oversight of a characteristic relationship between variables due to bias of an analyst or the like without requiring skill of the analyst.

### INDUSTRIAL APPLICABILITY

The present disclosure has been described in detail above with reference to the specific embodiments. However, it is obvious that those skilled in the art can make modifications and substitutions of the embodiments without departing from the scope of the present disclosure.

The present disclosure can be widely applied when multivariate analysis is performed in various fields such as medicine, pharmacy, physiology, engineering, agriculture, economics, humanities, and social science from an academic viewpoint, and in various industrial fields such as industry, agriculture, meteorology, medical, and service industries from an industrial viewpoint. The present disclosure can efficiently search for variables having a characteristic relationship from many variables, and can visualize and express a variable having a characteristic relationship and a numerical value indicating a relationship between variables.

In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.
(1) An information processing apparatus including:
a detection unit that detects a combination of two variables having a characteristic relationship in multivariate analysis; and
a presentation unit that presents information regarding the characteristic relationship between the two variables.
(2) The information processing apparatus according to (1),
in which the detection unit detects the two variables having the characteristic relationship having a different tendency from others under some conditions.
(3) The information processing apparatus according to any one of (1) and (2),
in which the detection unit detects the characteristic relationship by quantifying a relationship between the two variables that are qualitative variables and are ordinal scales by a mathematical formula.
(4) The information processing apparatus according to (3),
in which the detection unit derives a relationship between an explanatory variable and an explained variable for each of two consecutive categories of the explanatory variable, on the basis of a change in distribution of each category of the explained variable in the two consecutive categories of the explanatory variable, in a relationship between the explanatory variable and the explained variable that are qualitative variables and are ordinal scales.
(5) The information processing apparatus according to (4),
in which the detection unit detects whether or not there is a characteristic relationship including at least one of a positive correlation, a negative correlation, or a non-linear relationship as entire variables on the basis of the relationship between the explanatory variable and the explained variable for each of the two consecutive categories of the explanatory variable.
(6) The information processing apparatus according to any one of (4) and (5),
in which the detection unit further quantifies the relationship between the explanatory variable and the explained variable as entire variables.
(7) The information processing apparatus according to (6),
in which the detection unit calculates a correlation index indicating the relationship between the variables as the entire variables by summing, over all categories of the explanatory variable, sub-correlation indexes based on a change in an occupancy probability of an upper category of the explained variable and a change in an occupancy probability of a lower category of the explained variable between the two consecutive categories of the explanatory variable.
(8) The information processing apparatus according to (7),
in which the detection unit weights a sum of the change in the occupancy probability of the upper category and the change in the occupancy probability of the lower category of the explained variable between the two consecutive categories of the explanatory variable by a coefficient that increases as a sum of the number of samples of the two consecutive categories of the explanatory variable increases and as a change in the number of samples decreases, and calculates the sub-correlation index for each of the two consecutive categories of the explanatory variable.
(9) The information processing apparatus according to any one of (4) to (8),
in which the detection unit further calculates a mutual information amount between the explanatory variable and the explained variable.
(10) The information processing apparatus according to any one of (1) to (9),
in which the presentation unit presents information regarding a relationship between variables, the information including at least one of a mutual information amount between the variables that are qualitative variables and are ordinal scales, or a correlation index obtained by quantifying a strength of correlation as entire variables.
(11) The information processing apparatus according to any one of (1) to (10),
in which the presentation unit presents information regarding a correlation tendency of entire variables based on a correlation between an explanatory variable and an explained variable determined for each of two consecutive categories of the explanatory variable.
(12) The information processing apparatus according to (11),
in which the presentation unit presents information regarding a relationship between two variables, including whether the entire variables have a positive correlation, a negative correlation, or a non-linear relationship.
(13) The information processing apparatus according to any one of (1) to (12),
in which the presentation unit presents information regarding a relationship between the two variables with respect to an edge connecting the two variables in which the characteristic relationship is detected on a causal graph based on a result of multivariate analysis.
(14) The information processing apparatus according to (13),
in which the presentation unit highlights the edge connecting the two variables in which the characteristic relationship is detected on the causal graph.
(15) The information processing apparatus according to any one of (1) to (12),
in which the presentation unit presents information regarding a relationship between the two variables on a graph including nodes corresponding to the two variables in which the characteristic relationship is detected and an edge connecting the nodes.
(16) The information processing apparatus according to any one of (1) to (12),
in which the presentation unit presents information regarding a relationship between the two variables in a table format for each combination of variables.
(17) The information processing apparatus according to any one of (1) to (15),
in which the presentation unit presents a conditional probability chart or a conditional probability table between the two variables in which the characteristic relationship is detected.
(18) The information processing apparatus according to (17),
in which the presentation unit further presents a feature related to the relationship between the two variables in a form accompanying the conditional probability chart or the conditional probability table.
(19) An information processing method including:
a detection step of detecting a combination of two variables having a characteristic relationship in multivariate analysis; and
a presentation step of presenting information regarding the characteristic relationship between the two variables.
(20) A computer program written in a computer-readable format for causing a computer to function as:
a detection unit that detects a combination of two variables having a characteristic relationship in multivariate analysis; and
a presentation unit that presents information regarding the characteristic relationship between the two variables.

### REFERENCE SIGNS LIST

800 Information processing system
801 Data accumulation unit
802 Multivariate analysis unit
803 Detection unit
804 Presentation unit
2000 Information processing apparatus
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

1. An information processing apparatus comprising:
a detection unit that detects a combination of two variables having a characteristic relationship in multivariate analysis; and
a presentation unit that presents information regarding the characteristic relationship between the two variables.

2. The information processing apparatus according to claim 1,
wherein the detection unit detects the two variables having the characteristic relationship having a different tendency from others under some conditions.

3. The information processing apparatus according to claim 1,
wherein the detection unit detects the characteristic relationship by quantifying a relationship between the two variables that are qualitative variables and are ordinal scales by a mathematical formula.

4. The information processing apparatus according to claim 3,
wherein the detection unit derives a relationship between an explanatory variable and an explained variable for each of two consecutive categories of the explanatory variable, on a basis of a change in distribution of each category of the explained variable in the two consecutive categories of the explanatory variable, in a relationship between the explanatory variable and the explained variable that are qualitative variables and are ordinal scales.

5. The information processing apparatus according to claim 4,
wherein the detection unit detects whether or not there is a characteristic relationship including at least one of a positive correlation, a negative correlation, or a non-linear relationship as entire variables on a basis of the relationship between the explanatory variable and the explained variable for each of the two consecutive categories of the explanatory variable.

6. The information processing apparatus according to claim 4,
wherein the detection unit further quantifies the relationship between the explanatory variable and the explained variable as entire variables.

7. The information processing apparatus according to claim 6,
wherein the detection unit calculates a correlation index indicating the relationship between the variables as the entire variables by summing, over all categories of the explanatory variable, sub-correlation indexes based on a change in an occupancy probability of an upper category of the explained variable and a change in an occupancy probability of a lower category of the explained variable between the two consecutive categories of the explanatory variable.

8. The information processing apparatus according to claim 7,
wherein the detection unit weights a sum of the change in the occupancy probability of the upper category and the change in the occupancy probability of the lower category of the explained variable between the two consecutive categories of the explanatory variable by a coefficient that increases as a sum of the number of samples of the two consecutive categories of the explanatory variable increases and as a change in the number of samples decreases, and calculates the sub-correlation index for each of the two consecutive categories of the explanatory variable.

9. The information processing apparatus according to claim 4,
wherein the detection unit further calculates a mutual information amount between the explanatory variable and the explained variable.

10. The information processing apparatus according to claim 1,
wherein the presentation unit presents information regarding a relationship between variables, the information including at least one of a mutual information amount between the variables that are qualitative variables and are ordinal scales, or a correlation index obtained by quantifying a strength of correlation as entire variables.

11. The information processing apparatus according to claim 1,
wherein the presentation unit presents information regarding a correlation tendency of entire variables based on a correlation between an explanatory variable and an explained variable determined for each of two consecutive categories of the explanatory variable.

12. The information processing apparatus according to claim 11,
wherein the presentation unit presents information regarding a relationship between two variables, including whether the entire variables have a positive correlation, a negative correlation, or a non-linear relationship.

13. The information processing apparatus according to claim 1,
wherein the presentation unit presents information regarding a relationship between the two variables with respect to an edge connecting the two variables in which the characteristic relationship is detected on a network diagram in which nodes corresponding to each variable subjected to multivariate analysis are connected by an edge.

14. The information processing apparatus according to claim 13,
wherein the presentation unit highlights the edge connecting the two variables in which the characteristic relationship is detected on the network diagram.

15. The information processing apparatus according to claim 1,
wherein the presentation unit presents information regarding a relationship between the two variables on a graph including nodes corresponding to the two variables in which the characteristic relationship is detected and an edge connecting the nodes.

16. The information processing apparatus according to claim 1,
wherein the presentation unit presents information regarding a relationship between the two variables in a table format for each combination of variables.

17. The information processing apparatus according to claim 1,
wherein the presentation unit presents a conditional probability chart or a conditional probability table between the two variables in which the characteristic relationship is detected.

18. The information processing apparatus according to claim 17,
wherein the presentation unit further presents information regarding a probability transition of an explained variable accompanying a state transition of an explanatory variable in a form accompanying the conditional probability chart or the conditional probability table.

19. An information processing method comprising:
a detection step of detecting a combination of two variables having a characteristic relationship in multivariate analysis; and
a presentation step of presenting information regarding the characteristic relationship between the two variables.

20. A computer program written in a computer-readable format for causing a computer to function as:
a detection unit that detects a combination of two variables having a characteristic relationship in multivariate analysis; and
a presentation unit that presents information regarding the characteristic relationship between the two variables.
